(19) United States
(12) Patent Application Publication
(10) Pub. No.: US 2009/0183255 A1
(43) Pub. Date: Jul. 16, 2009

(54) SERVER SERVICES ON CLIENT FOR DISCONNECTED AUTHENTICATION

(76) Inventors: W. Scott Kiester, Orem, UT (US); Larry H. Henderson, Orem, UT (US); Karl E. Ford, Highland, UT (US)

Correspondence Address: KING & SCHICKLI, PLLC, 247 NORTH BROADWAY, LEXINGTON, KY, 40507, US

(21) Appl. No.: 11/962,443

(22) Filed: Dec. 21, 2007

(51) Int. Cl. G06F 13/00

(52) U.S. Cl. 726/18

(57) ABSTRACT

Methods and apparatus provide server services on a client for disconnected login on the client. Users execute a connected login sequence between the client and the server according to one of many strong authentication protocols. During such time, information on the server necessary for a successful execution of the strong authentication protocol is determined and provided to the client where it is stored in a local instance. Users thereafter disconnect from the server and login locally on the client Login information, locally provided, is verified against the information of the server so provided to the client. In this manner, users can be authenticated with a strong protocol, beyond mere password information. They can be strongly authenticated when logging-in to a laptop computing device, for example, when in a location not able to connect to a network appliance, such as a server.

### FIELD OF THE INVENTION

Generally, the present invention relates to computing environments involving accessing client workstations, especially by way of various strong authentication schemes, e.g., smart card, one-time passwords, fingerprint, DNA, retina scan, etc. Particularly, it relates to accessing client workstations with strong authentication while disconnected from network appliances, e.g., servers. Features of the invention include replicating server-based functionality on the client according to a particular authentication protocol to enable local client login according to the same authentication protocol but without any communication with the server. Other features contemplate computer program products, computing network systems, specific authentication protocols, and retrofit technology, to name a few.

### BACKGROUND OF THE INVENTION

Many authentication systems, such as Novell, Inc.'s Modular Authentication Service (NMAS), provide varying levels of strong authentication. NMAS, for instance, can authenticate users using biometrics (e.g., fingerprint, retina scan, etc.), tokens (one-time passwords, smart cards), and passwords. Security sensitive applications or resources, such as corporate financial information, personal and personnel information, military secrets, nuclear technology, banking activity, securities trading, health/patient records, etc., use these authentication services to prevent unauthorized users from gaining access. Third parties “plug” NMAS into their computing environment and write a Login Client Method (LCM), for a client workstation, and a Login Server Method (LSM), for a server. The LCM is methodology largely responsible for collecting authentication credentials from users at their workstation, e.g., receiving one-time passwords, receiving fingerprint data from a scanner, etc., while the LSM is methodology largely responsible for verifying the credentials.

The LCM and LSM communicate using proprietary NMAS API calls. These API calls take data provided by the caller, package it into MAF API packets, and send it over a network between the client workstation and server. The format of the data is not specified by NMAS, but is left to the discretion of the LCM/LSM developer. Login secrets (e.g., how one-time passwords are calculated, scanned fingerprint data for users, etc.) are stored for the server with the assistance of a computing product, such as Novell's eDirectory or Microsoft's Active Directory, and may be accessed from the LSM using NMAS API calls for storing and retrieving secrets.

However, it presently exists that NMAS or other products do not contemplate client-server disconnected scenarios. For example, when users travel with their laptops, they do not always have access to network resources, e.g., when sitting in an airport. Corporate policy or user preference, however, may still dictate logging-in with strong authentication despite not having network access. In this context, server-based solutions fail to provide client-only or disconnected login.

In other computing products, portions of an entire tree are replicated to a local eDirectory instance, for use by a remote office to prevent each user login from having to utilize a WAN, or other network. Such products, however, only replicate a hard-coded set of attributes intended for instances of static password authentications (i.e., LDAP simple binds). It affords no utility to strong authentication protocols, such as most of those found with the fifty-plus existing NMAS methods or other strong, multi-factor authentication frameworks, such as LDAP/SASL or OpenLDAP/SLAPD.

Accordingly, a need exists in the art of strong authentication to allow users to login while disconnected from network services. The need further extends to logging-in under a wide variety of possible authentication protocols. In that many computing configurations already have strong authentication services, it is further desirable to leverage existing configurations by way of retrofit technology, thereby avoiding the costs of providing wholly new products. Taking advantage of existing frameworks, such as NMAS, is another feature that optimizes existing resources. Any improvements along such lines should further contemplate good engineering practices, such as relative inexpensiveness, stability, ease of implementation, high security, low complexity, flexibility, etc.

### SUMMARY OF THE INVENTION

The foregoing and other problems become solved by applying the principles and teachings associated with the hereinafter-described server services on client for disconnected authentication. At a high level, methods and apparatus teach accessing client workstations with one or more strong authentication protocols while disconnected from network appliances, e.g., servers. Server-based functionality is replicated on the client when the two are in communication to enable later local client login according to a particular strong authentication protocol when the two are no longer in communication.

In a representative embodiment, users execute a connected login sequence between the client and the server according to one of many strong authentication protocols. During such time, information on the server necessary for a successful execution of the strong authentication protocol is determined and provided to the client where it is stored in a local instance. Users thereafter disconnect from the server and login locally on the client. Login information (e.g., one-time password, fingerprint, retina scan, etc.), locally provided, is verified against the information of the server earlier-provided to the client. In this manner, users can be authenticated with a strong protocol, beyond mere password information. They can be strongly authenticated when logging-in to a laptop computing device, for example, when in a location not able to connect to a network appliance, such as a server.

As an example, if users login at their workstation with a fingerprint that gets scanned and sent to a server for authentication, the received fingerprint is compared to a stored fingerprint for the user. If the two are the same, login is successful. If not, login is prevented. In turn, the workstation (when not connected to the server) requires an instance of the stored fingerprint for comparison to the scanned fingerprint, to which, the stored fingerprint is replicated on the workstation. Naturally, information needing to be replicated on the client workstation will vary according to the authentication method selected.

In the context of an NMAS/eDirectory computing arrangement, or other strong, multi-factor authentication frameworks, such as LDAP/SASL and PAM, the information or set of data that is replicated depends on the data accessed by the Login Server Method (LSM). It is learned on the go, at the server, as the LSM makes calls to the NMAS API, thus making foreknowledge of the actual strong authentication protocol at the client workstation irrelevant. In turn, what is learned is then forwarded to the client and stored for later disconnected login.

In a computing system embodiment, the invention may be practiced with: a client workstation; and a server all arranged as part of the pluralities of physical or virtual computing devices, including executable instructions for undertaking the foregoing methodology. Computer program products are also disclosed and are available as a download or on a computer readable medium. The computer program products are also available for installation on a network appliance, such as a server, or as retrofit technology with a strong authentication service, such as Novell, Inc.'s NMAS, with other strong, multi-factor authentication frameworks, such as LDAP/SASL with/without PAM, OpenLDAP/SLAPD, or elsewhere.

In still other embodiments, computing networks and party interaction are discussed, as are possible strong authentication schemes, e.g., smart card, one-time passwords, fingerprint, DNA, retina scan, etc.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a representative computing environment for server services on a client for disconnected login;

FIGS. 2 and 3 are flow charts in accordance with the present invention of representative organization for server services on a client for disconnected login;

FIGS. 4 and 5 are combined flow charts and diagrammatic views in accordance with the present invention for undertaking providing server services on a client for disconnected login;

FIG. 6 is a combined flow chart and diagrammatic view in accordance with the present invention of a more detailed representation of providing server services on a client for disconnected login; and

FIGS. 7 and 8 are flow charts in accordance with the present invention of optional embodiments.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus for server services on a client for disconnected login are hereinafter described.

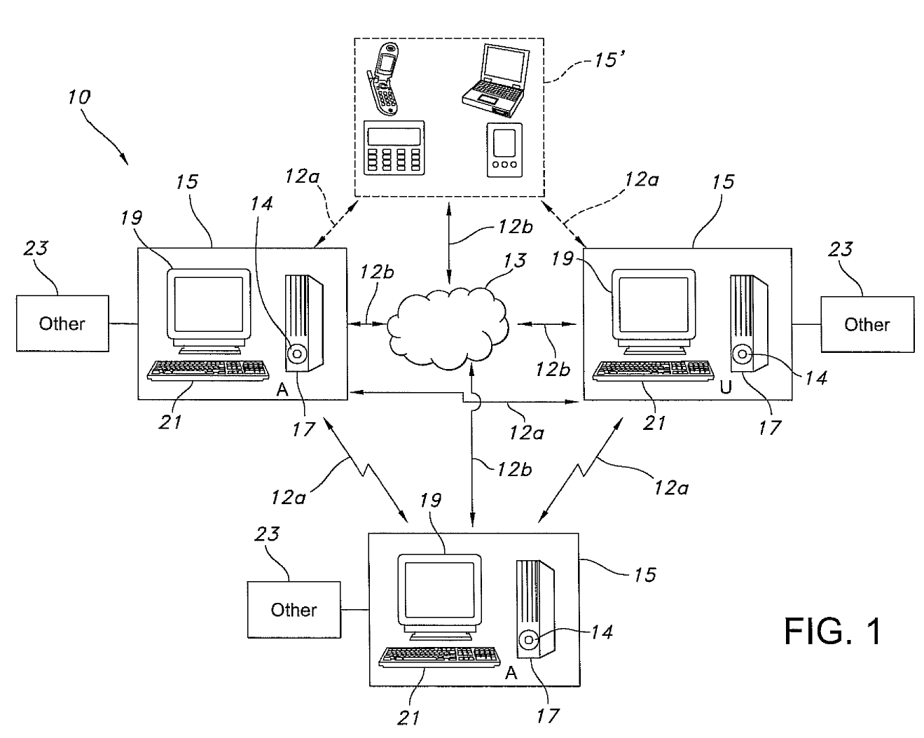

With reference to FIG. 1, a representative computing environment 10 for practicing certain or all aspects of the invention includes one or more computing devices 15 or 15′ arranged as individual or networked physical or virtual machines, including clients or hosts arranged with a variety of other networks and computing devices. In a traditional sense, an exemplary computing device typifies a server 17, such as a grid or blade server. Brand examples include, but are not limited to, a Windows brand Server, a SUSE Linux Enterprise Server, a Red Hat Advanced Server, a Solaris server or an AIX server. Alternatively, it includes a general or special purpose computing device in the form of a conventional fixed or mobile (e.g., laptop) computer 17 having an attendant monitor 19 and user interface 21. The computer internally includes a processing unit for a resident operating system, such as DOS, WINDOWS, MACINTOSH, LEOPARD, VISTA, UNIX, and LINUX, to name a few, a memory, and a bus that couples various internal and external units, e.g., other 23, to one another. Representative other items 23 include, but are not limited to, PDA's, cameras, scanners, printers, microphones, joy sticks, game pads, satellite dishes, hand-held devices, consumer electronics, minicomputers, computer clusters, main frame computers, a message queue, a peer computing device, a broadcast antenna, a web server, an AJAX client, a grid-computing node, a virtual machine, a web service endpoint, a cellular phone, or the like. The other items may also be stand alone computing devices 15′ in the environment 10 or the computing device itself.

In either, storage devices are contemplated and may be remote or local. While the line is not well defined, local storage generally has a relatively quick access time and is used to store frequently accessed data, while remote storage has a much longer access time and is used to store data that is accessed less frequently. The capacity of remote storage is also typically an order of magnitude larger than the capacity of local storage. Regardless, storage is representatively provided for aspects of the invention contemplative of computer executable instructions, e.g., software, as part of computer program products on readable media, e.g., disk 14 for insertion in a drive of computer 17. Computer executable instructions may also be available for installation as a download or reside in hardware, firmware or combinations in any or all of the depicted devices 15 or 15′.

When described in the context of computer program products, it is denoted that items thereof, such as modules, routines, programs, objects, components, data structures, etc., perform particular tasks or implement particular abstract data types within various structures of the computing system which cause a certain function or group of functions. In form, the computer product can be a download of executable instructions resident with a downstream computing device, or readable media, received from an upstream computing device or readable media, a download of executable instructions resident on an upstream computing device, or readable media, awaiting transfer to a downstream computing device or readable media, or any available media, such as RAM, ROM, EEPROM, CD-ROM, DVD, or other optical disk storage devices, magnetic disk storage devices, floppy disks, or any other physical medium which can be used to store the items thereof and which can be assessed in the environment.

In network, the computing devices communicate with one another via wired, wireless or combined connections 12 that are either direct 12a or indirect 12b. If direct, they typify connections within physical or network proximity (e.g., intranet). If indirect, they typify connections such as those found with the internet, satellites, radio transmissions, or the like, and are given nebulously as element 13. In this regard, other contemplated items include servers, routers, peer devices, modems, T# lines, satellites, microwave relays or the like. The connections may also be local area networks (LAN) and/or wide area networks (WAN) that are presented by way of example and not limitation. The topology is also any of a variety, such as ring, star, bridged, cascaded, meshed, or other known or hereinafter invented arrangement.

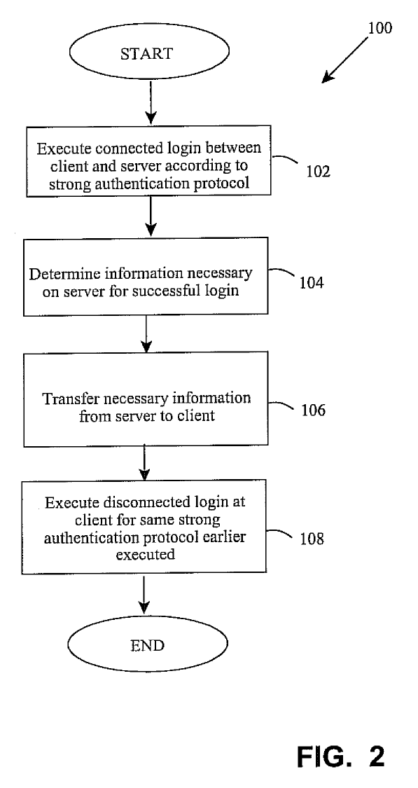

With the foregoing representative computing environment as backdrop, FIG. 2 teaches a high level organization 100 for server services on a client for disconnected login. At step 102, users execute a connected login sequence between the client workstation and a server according to one of many strong authentication protocols. During such time, step 104, information on the server necessary for a successful execution of the strong authentication protocol is determined and, step 106, provided or transferred to the client where it is stored in a local instance. Users thereafter literally or figuratively disconnect from the server (e.g., physically disconnect computing cords or, figuratively, by being out of communication with the server) and login locally on the client, step 108. They verifying locally provided login information for the strong authentication protocol against the information of the server earlier provided to the client at step 106. In this manner, users can be authenticated with a strong protocol, beyond mere password information. They can log-in to a laptop computing device, for example, when in a location (e.g., airport) not able to connect to a network appliance, such as a server.

As a representative example, if users login at their workstation with an employee bar code that gets scanned and sent to a server for authentication, the received bar code is compared to a stored bar code value for the user. If the two are the same, login between the server and client workstation is successful. If not, login is unsuccessful, including perhaps limiting or preventing total workstation functionality. In turn, the workstation (when not connected to the server) requires an instance of the stored bar code value of the server for comparison to the scanned bar code, to which, the stored bar code value is replicated on the client workstation when the server and client are in communication. Thereafter, users disconnect from the server and login locally on the client by scanning their employee bar code. The scanned login information (e.g., bar code) is verified against the bar code value information of the server earlier replicated. If the two are the same (scanned bar code is the same as the replicated bar code value), disconnected login of the client is successful. Otherwise, login is unsuccessful and, as before, whole or partial computing functionality of the client may be prevented. As will be seen below, information needing to be replicated on the client workstation varies according to the authentication method selected.

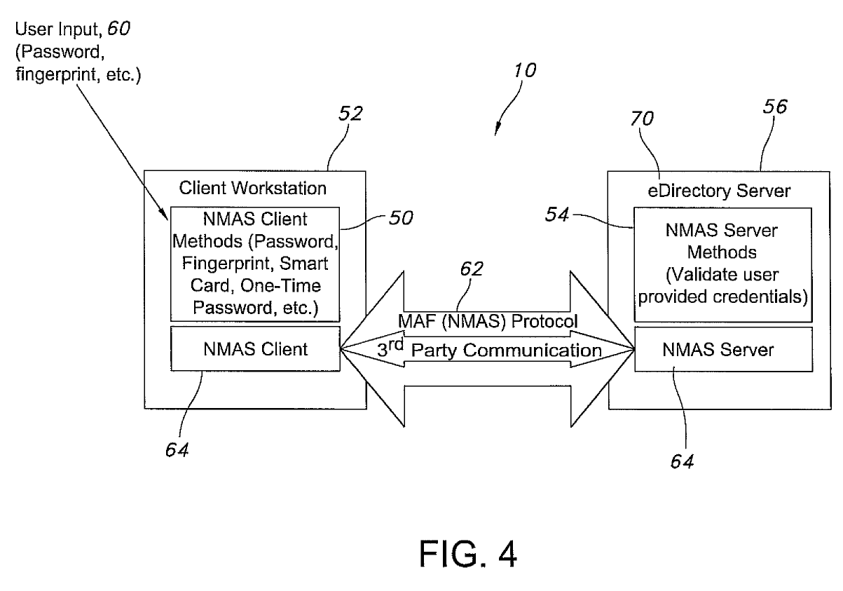

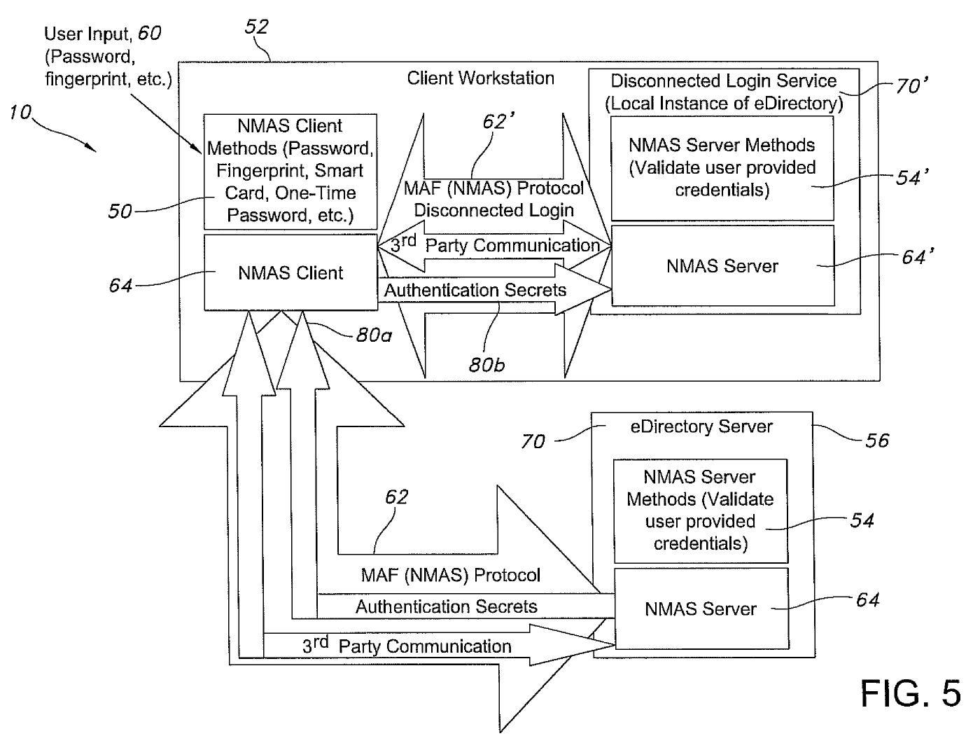

With reference to FIGS. 4 and 5, a more detailed example of an embodiment of the invention is given in the context of an NMAS/eDirectory computing arrangement, representative of a strong, multi-factor authentication framework. Others existing frameworks relevant to this scenario include, but are not limited to, LDAP/SASL or OpenLDAP/SLAPD. Other applicable directories include, Active Directory or Sun One, for instance, but appreciating Active Directory is not nearly as lightweight as eDirectory.

With NMAS, third parties “plug” the computing program product into their computing environment 10 and write/provide a Login Client Method (LCM) 50 for a client workstation 52 and a Login Server Method (LSM) 54 for a server 56, as is known. In general, the LCM is methodology largely responsible for collecting authentication credentials (user input information 60) from users at their workstation, e.g., receiving one-time passwords, receiving fingerprint data from a scanner, receiving an employee bar code, etc., while the LSM is methodology largely responsible for verifying the credentials per a user, a workgroup, or other arrangement.

Also, NMAS may be outfitted with various schemes providing varying levels of strong authentication. In one instance, the authentication schemes relate to user-fixed characteristics such as biometrics in the form of fingerprints, retina scans, DNA, etc. In another, they relate to electronic structures, such as smart cards, microchips, magnetic stripes, etc. In still another, they are user-created, such as passwords, secrets, usernames, PINS, or other credentials. Regardless of form, they are referred to generically herein as protocols, schemes, etc. and users log-in from their workstation, including navigation with apparatus such as card readers, retina or fingerprint scanners, password forms, keypads, etc., as is typical. (In certain embodiments, the workstation may be simply a computing device in the form of a card reader, retina or fingerprint scanner, password form, keypad, etc., such as 15′ in FIG. 1 without the more traditional form of element 15 in FIG. 1.)

When the client workstation and server are in communication, such as during execution of connected login (step 102, FIG. 2), the LCM and LSM communicate using proprietary NMAS API calls 62. These API calls take data provided by the caller, package it into MAF (Multi-mode Authentication Framework) API packets, and send it over a network between the client workstation 52 and server 56, especially between the NMAS client 64 and NMAS server 66. In turn, the NMAS client and server communicate with the LCM and LSM, respectively. The format of the data is not specified by NMAS, but is left to the discretion of the LCM/LSM developer. Actual login secrets (e.g., how one-time passwords are calculated, scanned fingerprint data per specific users, employee card values for users, workgroups, etc.) are stored for the server with the assistance of a computing product, such as Novell's eDirectory 70. As will be seen, this arrangement enables the strong, multi-factor authentication framework, to replicate necessary information or data on the client workstation for disconnected login. Also, the necessary information is dynamically learned on the fly at the server as the LSM makes calls to the NMAS API, thus making foreknowledge of the actual strong authentication protocol (e.g., one-time password, fingerprint, employee bar code, etc.) at the client workstation largely irrelevant. Ultimately, what is learned is forwarded to the client and stored for later disconnected login. It is used by the client in the same manner as if connected to the server, thereby largely minimizing any alteration of the LCM and NMAS client.

For instance, FIG. 5 shows a disconnected login service 70′ that is provided on the user's local workstation. This service is an instance of eDirectory that was bound only to the local network interface (i.e., loopback interface). When the user performs a successful connected authentication against the corporate eDirectory server 70, the user's authentication secrets are sent from the NMAS server 64 to the client workstation, where they are stored in the local eDirectory instance 70′. Within the workstation, the authentication secrets are passed 80b from the NMAS client 64 to an instance of the NMAS server 64′. Thereafter, when users perform disconnected authentication, the LSM 54′ will be invoked from the local instance of eDirectory 70′, which now has a copy of the secrets it needs to authenticate the user. Communication occurs between the LCM 50 and LSM 54′ using proprietary NMAS API calls 62′ similar to those earlier-described as 62 between the client workstation 52 and the server 56, especially between the NMAS client 64 and NMAS server 66 during the times of connection between the client and server.

In actually assessing the information or data stored for disconnected login, it is determined what exact NMAS API calls were executed during the connected login. The data accessed by these API calls is then the data that is sent 80a, 80b to the client workstation. This ensures that the secrets stored for disconnected login are only those that are required to perform the requested authentication, and no more.

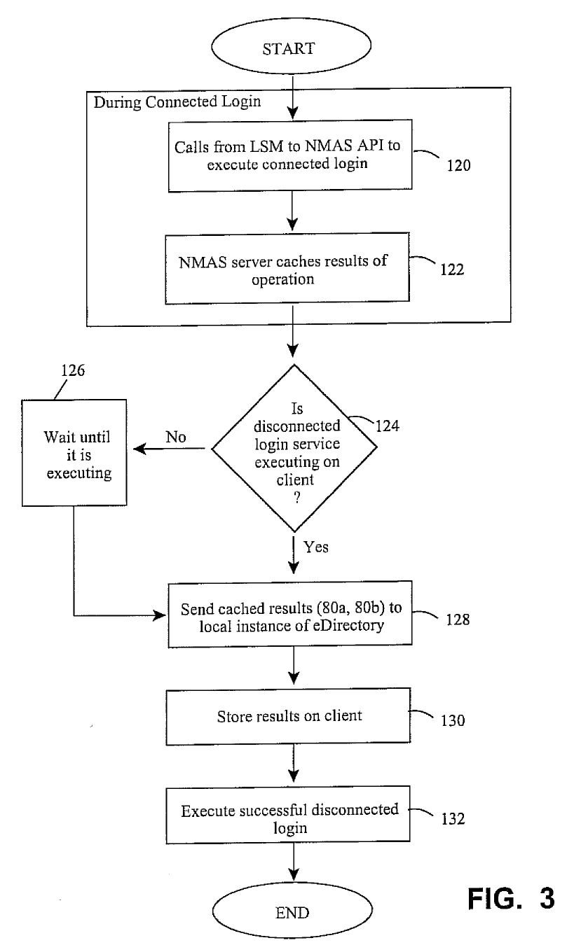

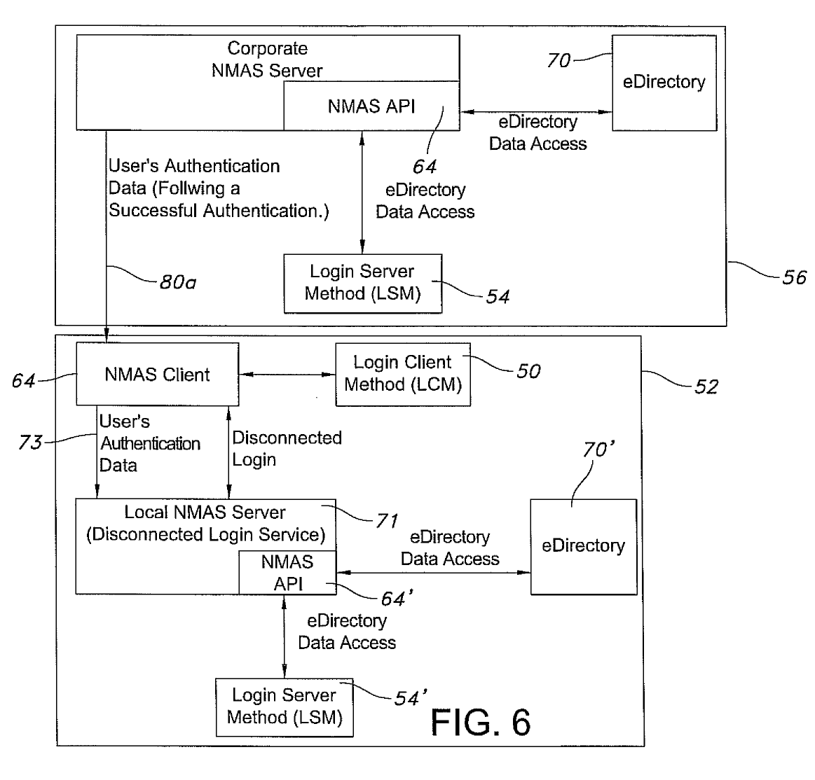

With reference to FIGS. 3 and 6, and the EXAMPLE below, a more detailed explanation is given. It exists also in the context of NMAS and a strong authentication protocol in the form of a one-time password for Vasco corporation's Digipass product.

### EXAMPLE

1) The user initiates Client32 NCP login on the client workstation 52 using the Vasco Digipass login method.

2) The NMAS Client invokes the Vasco Digipass LCM 50, which prompts the user for the token code. The user enters the token code and the token code is sent to the LSM 54.

3) The LSM 54 receives the token code. To verify the token code, the LSM must look up the token that is assigned to the user. For the Vasco method, the token is a separate object in eDirectory 70 that is linked to the user using an attribute called vascoAssignedTokenDN. The Digipass LSM calls NMAS API 64 to read the vascoAssignedTokenDN attribute from the user, step 120. NMAS reads the attribute from the user in eDirectory 70 and returns the results to Vasco LSM 54. NMAS also stores the results of the read operation in a disconnected login cache associated with the login session, step 122.

4) The LSM 54 calls (step 120) NMAS_GetLoginSecret to read the token seed from the token object in eDirectory 70. Again, NMAS caches the results of the operation, step 122.

5) The LSM 54 validates the token code provided by the user. Login is successful. Otherwise, if the token code is invalid, login is unsuccessful and certain or all functionality of the client workstation is prevented.

6) Before closing the login session, NMAS checks to see if the disconnected login service is executing or running on the client, step 124. If it is, NMAS sends 80a the results of the read operations performed in steps 3) and 4) to the disconnected login service 71, step 128. The disconnected login service stores this data on a user object in a local instance of eDirectory 70′, step 130. On the other hand, if the disconnected login service is not executing on the client, the results, e.g., secrets, are delayed until some later time, step 126.

7) The user leaves the office with his laptop. The next time he tries to log in, he is at the airport and has no network access. The user checks the “Workstation Only” box in Client32, and attempts to log in. Because the user has installed the NMAS disconnected login service 71, the disconnected login service is invoked instead of Windows login.

8) The NMAS Client 64 invokes the Vasco LCM 50, which prompts the user for the token code.

9) The token code is sent to the disconnected login service 73, which invokes the local Vasco LSM 54′. The Vasco LSM is able to read the same data as in step 3, because it was stored in the local instance of eDirectory 70′ in step 6).

10) Authentication is complete and the disconnected login is successful, step 132. The disconnected login service reads the user's Windows password locally from Secret Store. (The password was synchronized in step 6).)

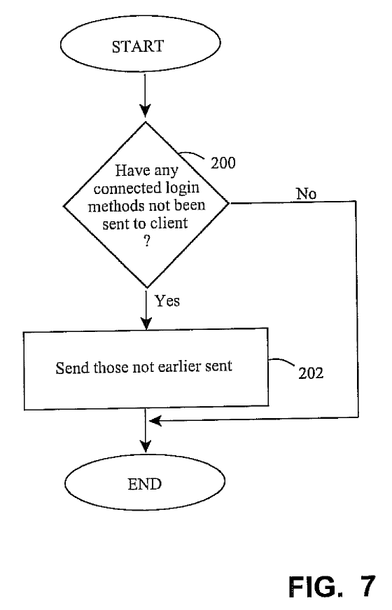

With reference to FIG. 7, skilled artisans will appreciate that various imperfections of communication between the client and server might cause failure of replicating necessary information on the client. Thus, during times of actual communication between the client and server, it is determined whether any secrets of all earlier-executed strong authentication protocols between the client and server remain to be provided on the client, step 200. If they have not all been provided, those not earlier sent are now sent (80a, 80b) to the client, step 202. Otherwise, nothing is left to send and this functionality ceases. The determination, step 200, can occur periodically, at specific times, randomly, etc., and may run in the background during other client/server events or at a specified times.

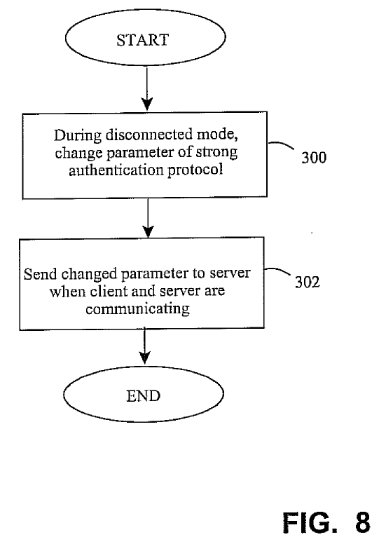

With reference to FIG. 8, it may be the situation that a user of the client workstation, while in a disconnected (from the server) mode of operation, causes a parameter of the strong authentication protocol to change, step 300. At some later time when the client and server are indeed communicating, the changed parameter is sent to the server, step 302. It is then stored by the LSM 54 (FIG. 5) and later used as part of the connected login between the client and workstation. Examples of a changed parameter include, but are not limited to, a changed password, a changed PIN, a changed employee identification number, etc.

In any embodiment, certain advantages and benefits over the prior art should be readily apparent. For example, methods and apparatus teach an arrangement of computing devices whereby accessing client workstations with one or more strong authentication protocols is possible while disconnected from network appliances, e.g., servers. Server-based functionality is replicated on the client when the two are in communication to enable later local client login according to a particular strong authentication protocol when the two are no longer in communication. Advantages of the disconnected login include, but are not limited to: 1) avoiding communication over a network, such as a WAN; 2) avoiding strict adherence to providing only a hard-coded set of attributes; 3) allowing strong authentication in geographic locations not earlier able to provide strong authentication; and 4) leveraging existing configurations, such as NMAS, by way of retrofit technology, thereby avoiding the costs associated with providing wholly new products.

Still other advantages exist in the form of authentication schemes and party interaction as well as computer program products, computing networks and computing devices, to name a few. Also, features of the invention make it possible to use existing login methods, without modification, for disconnected login. That is, the set of data synchronized to a client workstation is dynamic. To the extent a third party's desired strong authentication protocol is that of using fingerprints (compared to stored fingerprints) to login, the login need not change, but be merely replicated as necessary information (e.g., the stored fingerprint (secret)) on the client. The invention extends further to solving a non-network-available problem in a general way that can be applied to any multi-factor authentication framework, e.g., PAM with LDAP/SASL. Naturally, skilled artisans will be able to contemplate others.

One of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become evident to those skilled in the art upon reading this disclosure and may be made without departing from the spirit or scope of the invention. Relatively apparent modifications, of course, include combining the various features of one or more figures with the features of one or more of other figures.

1. In a computing system environment, a method of providing server services on a client for disconnected login on the client, comprising:
during execution of a connected login sequence between the client and the server according to a first authentication protocol, determining information on the server that is necessary for a successful execution of the connected login sequence; and
causing the determined information to be provided on the client to thereafter enable local login on the client according to the first authentication protocol without any communication with the server.

2. The method of claim 1, wherein the causing the determined information further includes replicating information of the server on the client.

3. The method of claim 1, further including determining whether a login service is executing on the client before the causing the determined information to be provided on the client.

4. The method of claim 1, wherein the first authentication protocol is a multiple factor authentication framework and the determining information on the server that is necessary for the successful execution of the connected login sequence further includes observing multiple calls of a DLL to an API of the server.

5. The method of claim 1, wherein the determining information on the server that is necessary for the successful execution of the connected login sequence further includes further including determining results of reads and writes relative to and from an API of the server.

6. The method of claim 5, further including providing a local instance of the determined results on the client.

7. The method of claim 1, wherein the first authentication protocol is a multiple factor authentication framework and the determining information on the server that is necessary for the successful execution of the connected login sequence further includes determining one of a token attribute, a fingerprint attribute, a retina scan attribute, a smart card attribute, a one-time password attribute, or a DNA attribute.

8. In a computing system environment, a method of providing server services on a client for completely disconnected login on the client, comprising:
facilitating a connected login sequence between the client computing device and the server computing device according to a strong authentication protocol;
determining information on the server that is necessary for a successful execution of the strong authentication protocol during the connected login sequence;
providing the determined information on the client to thereafter enable local login on the client according to said strong authentication protocol; and
enabling successful login of the client without any communication with the server upon receiving user information entered into the client and causing verification of the user information against the determined information provided on the client.

9. The method of claim 8, further including determining whether a login service is executing on the client before the providing the determined information on the client.

10. The method of claim 8, further including changing a parameter of the strong authentication protocol when the client is said without any communication with the server.

11. The method of claim 10, further including providing the changed parameter of the strong authentication protocol to the server at a time when the client is later in communication with said server.

12. In a computing system environment, a method of providing server services on a client for completely disconnected login on the client, comprising:
facilitating a connected login sequence between the client and the server according to a plurality of strong authentication protocols other than mere password information;
upon selection of at least one of the strong authentication protocols, determining information on the server that is necessary for a successful execution of the at least one of the strong authentication protocols during the connected login sequence; and
providing the determined information on the client to thereafter enable local login on the client according to the at least one of the strong authentication protocols without any communication of the server.

13. The method of claim 12, further including enabling successful login of the client upon receiving user information entered into the client regarding the at least one of the strong authentication protocols and verifying the user information against the determined information provided on the client.

14. The method of claim 12, further including determining information on the server that is necessary for a successful execution of a second of the strong authentication protocols during a second connected login sequence between the client and the server according to said second of the strong authentication protocols.

15. The method of claim 14, further including providing the determined information on the client to thereafter enable local login on the client according to said second of the strong authentication protocols without any communication with the server.

16. A computer program product available as a download or on a computer readable medium for loading on a computing device of a plurality of computing devices, the computer program product having executable instructions to provide server services on a client for disconnected login on the client, comprising:
a first component for installation on a server as part of the pluralities of computing devices, the first component to communicate with a client workstation of the pluralities of computing devices for a user to login to at least one login protocol of a plurality of authentication protocols during a connection between the client workstation and the server;
a second component for installation on the server to determine information on the server that is necessary for a successful execution of the at least one login protocol; and
a third component for installation on the server to cause the determined information to be provided on the client workstation to thereafter enable local login on the client workstation according to the at least one login protocol without any communication with the server.

17. The computer program product of claim 16, further including a fourth component to determine whether a login service is executing on the client workstation before the third component causes the determined information to be provided on the client.

18. The computer program product of claim 16, further including a fourth component to cache results of reads and writes relative to and from an API of the server.

19. A computing system environment having pluralities of computing devices arranged to provide server services on a client for disconnected login on the client, comprising:
a client workstation arranged as part of the pluralities of computing devices; and
a server arranged as part of the pluralities of computing devices connected and disconnected at various times to the client workstation, the server and client workstation having at least one authentication protocol that a user of the client workstation logs in to during a time of connection between the client workstation and the server, wherein the server is further configured to determine information on the server that is necessary for a successful execution of the at least one authentication protocol and to provide the determined information to the client workstation so the user can thereafter successfully login on the client workstation according to the at least one authentication protocol without any communication with the server.

20. The system of claim 19, further including an NMAS and an eDirectory or Active Directory computer program on the server.
